(19) United States
(12) Patent Application Publication
(10) Pub. No.: US 2021/0273343 A1
(43) Pub. Date: Sep. 2, 2021

(54) ANTENNA DEVICE, WIRELESS COMMUNICATION DEVICE, AND RADAR DEVICE

(71) Applicant: Sony Corporation, Tokyo (JP)

(72) Inventor: Takahiro TAKEDA, Kanagawa (JP)

(73) Assignee: Sony Corporation, Tokyo (JP)

(21) Appl. No.: 17/259,202

(22) PCT Filed: Aug. 7, 2019
(86) PCT No.: PCT/JP2019/031231

§ 371 Date: Jan. 11, 2021

(30) Foreign Application Priority Data
Aug. 7, 2018 (JP) 2018-148774

(51) Int. Cl. H01Q 19/28; H01Q 1/24; H01Q 1/32; H01Q 19/10

(52) U.S. Cl. CPC H01Q 19/28; H01Q 1/243; G01S 7/032; H01Q 19/104; H01Q 1/32

(57) ABSTRACT

Provided is an antenna device which includes: an antenna element (31) that transmits or receives a radio wave; a radome (20) that covers the antenna element (31); and one first wave director (21) or a plurality of first wave directors (21) that is provided on at least any one of an external surface or an internal surface of the radome (20).

### TECHNICAL FIELD

The present disclosure relates to an antenna device, a wireless communication device, and a radar device.

### BACKGROUND ART

In recent years, as technologies for enhancing performance of antennas, various technologies have been known. For example, there has been disclosed a technology which enhances the performance of an antenna by working a shape of a dome (hereinafter, also simply referred to as a “radome”), which protects the antenna, into a complicated shape (for example, a lens shape) (for example, refer to Patent Document 1).

### CITATION LIST

### Patent Document

Patent Document 1: Japanese Patent Application Laid-Open No. 2016-219996

### SUMMARY OF THE INVENTION

### Problems to be Solved by the Invention

However, in order to work the shape of the radome into the complicated shape, a lot of costs (manufacturing costs) are easily required and a size of the radome is easily increased. Accordingly, it is desirable to provide a technology which allows antenna performance to be enhanced while reducing manufacturing costs of an antenna device and inhibiting a size of the antenna device from increasing.

### Solutions to Problems

According to the present disclosure, provided is an antenna device which includes: an antenna element that transmits or receives a radio wave; a radome that covers the antenna element; and one first wave director or a plurality of first wave directors that is provided on at least any one of an external surface or an internal surface of the radome.

According to the present disclosure, provided is a wireless communication device which includes: an antenna device having: an antenna element that transmits or receives a wireless signal; a radome that covers the antenna element; and one first wave director or a plurality of first wave directors that is provided on at least any one of an external surface or an internal surface of the radome; and a wireless communication circuit that causes the antenna element to transmit or receive the wireless signal.

According to the present disclosure, provided is a radar device which includes: an antenna device having an antenna element that transmits or receives a radar wave; a radome that covers the antenna element; and one first wave director or a plurality of first wave directors that is provided on at least any one of an external surface or an internal surface of the radome; and a radar transmission circuit that causes the antenna element to transmit or receive the radar wave.

### Effects of the Invention

As described above, according to the present disclosure, provided is a technology which allows antenna performance to be enhanced while reducing manufacturing costs of an antenna device and inhibiting a size of the antenna device from increasing. Note that the above-mentioned effect is not necessarily restrictive and any effect described in the present description or other effect which can be comprehended from the present description, as well as or instead of the above-mentioned effect, may be exhibited.

### BRIEF DESCRIPTION OF DRAWINGS

FIG. 1 is an exploded perspective view of an antenna device according to a first embodiment of the present disclosure.

FIG. 2 is an external view of the antenna device according to the first embodiment.

FIG. 3 is a cross-sectional view of the antenna device, viewed along arrows A-A shown in FIG. 2.

FIG. 4 is a diagram for explaining comparative examples.

FIG. 5 is a diagram showing an example of relationship between numbers of dipole antennas and wave directors and each gain.

FIG. 6 is a diagram showing comparison of sizes of a dielectric lens antenna and the antenna device according to the present embodiment.

FIG. 7 is a diagram showing a configuration example of a radar device to which the antenna device according to the first embodiment is applied.

FIG. 8 is a diagram showing a configuration example of a wireless communication device to which the antenna device according to the first embodiment is applied.

FIG. 9 is an external view of an antenna device according to a second embodiment of the present disclosure.

FIG. 10 is a cross-sectional view of the antenna device, viewed along arrows B-B shown in FIG. 9.

FIG. 11 is a diagram showing an example in which lengths of respective portions of the antenna device according to the second embodiment are shown.

FIG. 12 is a diagram showing an example of relationship of respective numbers of dipole antennas and wave directors and a gain.

FIG. 13 is an external view of an antenna device according to a first modified example.

FIG. 14 is an external view of an antenna device according to a second modified example.

FIG. 15 is a cross-sectional view of the antenna device, viewed along arrows C-C shown in FIG. 14.

### MODE FOR CARRYING OUT THE INVENTION

Hereinafter, with reference to the accompanying drawings, preferred embodiments of the present disclosure will be described in detail. Note that in the present description and the drawings, components having substantially the same function configurations are denoted by the same reference signs and duplicate description therefor will be thereby omitted.

In addition, in the present description and the drawings, there may be a case where components whose number is plural and which have substantially the same or similar function configurations are distinguished by adding different numerals utter the same reference signs. However, in a case where it is not necessary to distinguish the components whose number is plural and which have substantially the same or similar function configurations, the components are denoted only by the same reference signs. In addition, there may be a case where components in different embodiments, which are similar, are distinguished by adding different alphabets after the same reference signs. However, in a case where it is not necessary to distinguish the similar components, the similar components are denoted only by the same reference signs.

Note that description will be given in the following order.

0. Outline

1. Detail of First Embodiment

1.1. Configuration Example of Antenna Device

1.2. Description of Effect

1.3. Examples of Application

2. Detail of Second Embodiment

2.1. Configuration Example of Antenna Device

2.2. Description of Effect

3. Modified Examples

4. Closing Remarks

### 0. Outline

First, an outline of the embodiments of the present disclosure will be described. In recent years, as technologies for enhancing performance of antennas, various technologies have been known. For example, there has been disclosed a technology which enhances the performance of an antenna by working a shape of a dome (hereinafter, also simply referred to as a “radome”), which protects the antenna, into a complicated shape (for example, a lens shape).

However, in order to work the shape of the radome into the complicated shape, a lot of costs (manufacturing costs) are easily required and a size of the radome is easily increased. Accordingly, in the present description, a technology which allows antenna performance to be enhanced while reducing manufacturing costs of an antenna device and inhibiting a size of the antenna device from increasing will be mainly described.

Hereinbefore, the outline of the embodiments of the present disclosure is described.

### 1. Detail of First Embodiment

Hereinafter, detail of a first embodiment of the present disclosure will be described.

### 1.1. Configuration Example of Antenna Device

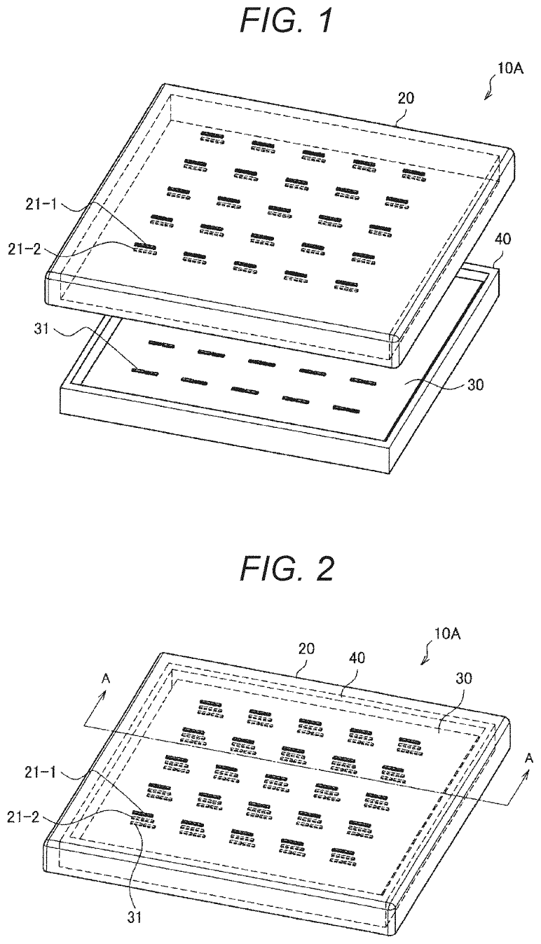

First, a configuration example of an antenna device according to the first embodiment of the present disclosure will be described. FIG. 1 is an exploded perspective view of the antenna device according to the first embodiment of the present disclosure. As shown in FIG. 1, an antenna device 10A according to the first embodiment of the present disclosure includes a radome 20, an antenna substrate 30, and a housing 40.

As shown in FIG. 1, inside the housing 40, the antenna substrate 30 can be housed. On a surface of the antenna substrate 30, antenna elements 31 are provided. For example, as shown in FIG. 1, the antenna elements 31 may be provided on an upper surface of the antenna substrate 30. Although reference signs are appropriately omitted in FIG. 1, shown therein is an example in which in a predetermined direction of the upper surface of the antenna substrate 30, the antenna elements 31 in five rows are provided and in a predetermined direction and a vertical direction, the antenna elements 31 in five columns are provided. In other words, shown therein is a case where the antenna elements 31 whose number is 25 which is calculated by multiplying the number of the antenna elements 31 in the five rows, which is five, by the number of the antenna elements 31 in the five columns, which is five. However, the number of the antenna elements 31 may be appropriately set as described later.

Herein, as shown in FIG. 1, a case where each of the antenna elements 31 is a dipole antenna is mainly supposed. For example, in a case where each of the antenna elements 31 is a half-wavelength dipole antenna, a feeding point may be provided at a center of the antenna which has a length of one half of a wavelength λ of a radio wave. However, a kind of the antenna elements 31 is not limited. For example, each of the antenna elements 31 may a patch antenna, a loop antenna, or an antenna (metamaterial antenna) utilizing a metamaterial. In other words, each of the antenna elements 31 may include at least any one of the patch antenna, the dipole antenna, the loop antenna, or the metamaterial antenna.

Each of the antenna elements 31 is provided on the surface of the antenna substrate 30 (the upper surface of the antenna substrate 30 in the example shown in FIG. 1) and transmits or receives a radio wave. In the first embodiment of the present disclosure, a case where each of the antenna elements 31 transmits or receives a millimeter wave as an example of the radio wave is mainly supposed. In the above-mentioned case, if a reflected wave of a millimeter wave, which is transmitted from each of the antenna elements 31, reflected from an object is received by each of the antenna elements 31, the object which is present therearound can be detected on the basis of a reception result of the reflected wave (each of the antenna elements 31 can be used as a millimeter wave radar). However, the radio wave which is transmitted or received by each of the antenna elements 31 is not limited to the millimeter wave. For example, the radio wave which is transmitted or received by each of the antenna elements 31 may be a microwave.

For example, in a case where the antenna device 10A is mounted on an on-vehicle device, if the reflected wave of the radio wave, transmitted by the antenna elements 31, from the object is received by the antenna elements 31, the object which is present around a vehicle can be detected on the basis of a reception result of the reflected wave. However, a kind of the device on which the antenna device 10A is mounted is not limited. For example, the antenna device 10A may be mounted on a drone, may be mounted on a robot, may be mounted on a mobile device (for example, a smartphone, a mobile telephone, a tablet terminal, or the like), or may be mounted on a speaker (for example, artificial intelligence (AI) speaker or the like).

The radome 20 is made to cover the housing 40 in which the antenna substrate 30 is housed. This allows the radome 20 to cover the antenna elements 31 and to protect the antenna elements 31. In order to inhibit a transmission loss of the radio wave caused by the radome 20, as a material of the radome 20, it is desirable to select a material having low permittivity, and a low dielectric loss tangent. On an external surface of the radome 20, wave directors 21-1 (first wave directors) are provided, and on an internal surface of the radome 20, wave directors 21-2 (first wave directors) are provided. As described above, in the first embodiment of the present disclosure, a case where on the respective external surface and internal surface of the radome 20, the wave directors 21 are provided is mainly supposed.

By employing the above-described configuration, directivity of the antenna is further largely intensified by the wave directors 21 which are provided on the respective external surface and internal surface of the radome 20. However, the wave directors 21 may be provided only on one of the external surface or internal surface of the radome 20. In other words, it is only required for the wave directors 21 to be provided on at least any one of the external surface or internal surface of the radome 20. This intensifies the directivity of the antenna.

According to the first embodiment of the present disclosure, the directivity of the antenna is intensified, thereby allowing antenna performance to be enhanced even without making a shape of the radome 20 a complicated shape. Accordingly, according to the first embodiment of the present disclosure, the antenna performance can be enhanced while manufacturing costs of the antenna device 10A are reduced and a size of the antenna device 10A is inhibited from increasing. As one example, the directivity of the antenna is intensified and resolution of the object detection based on the reception result of the reflected wave is thereby enhanced, thus enabling the object detection to be performed at a high accuracy.

The wave directors 21 may be formed by patterning on the respective external surface and internal surface of the radome 20 (by using laser plating or the like). This allows the wave directors 21 to be easily provided on the external surface and internal surface of the radome 20. Note that in the first embodiment of the present disclosure, a case where the wave directors 21 are provided on the respective external surface and internal surface of the radome 20 by directly connecting the wave directors 21 on the respective external surface and internal surface of the radome 20 is mainly supposed. However, the wave directors 21 may be provided on the respective external surface and internal surface of the radome 20 by indirectly connecting the wave directors 21 via other members on the respective external surface and internal surface of the radome 20.

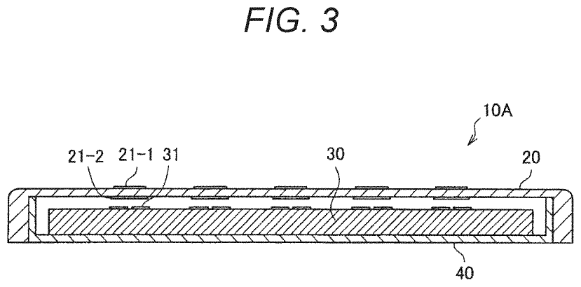

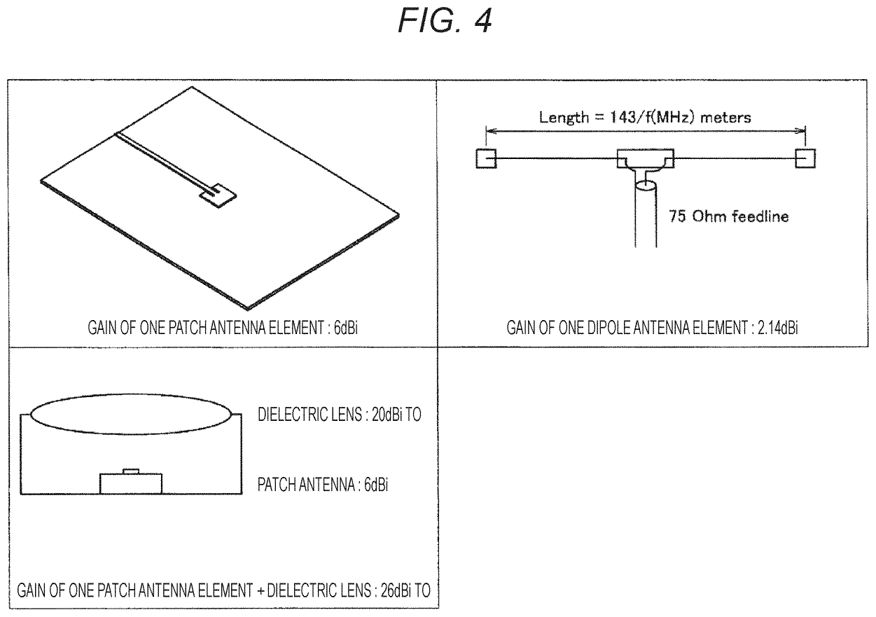

FIG. 2 is an external view of the antenna device 10A according to the first embodiment of the present disclosure. In addition, FIG. 3 is a cross-sectional view of the antenna device 10A, viewed along arrows A-A shown in FIG. 2. As shown in FIGS. 2 and 3, for example, although the housing 40 has a bottom surface and side surfaces, the housing 40 does not have an upper surface (an upper portion thereof is open). On the other hand, although the radome 20 has an upper surface and side surfaces, the radome 20 does not have a lower surface (a lower portion thereof is open). Therefore, as shown in FIGS. 2 and 3, in a case where the radome 20 is made to cover the housing 40, each of the antenna elements 31 provided on the surface of the antenna substrate 30 which is housed in the housing 40 faces each of the wave directors 21-2, which are provided on the internal surface of the radome 20, with a space sandwiched therebetween.

Although in FIGS. 2 and 3, the reference signs are appropriately omitted, a position of each of the wave directors 21-1 provided on the external surface of the radome 20 and a position of each of the wave directors 21-2 provided on the internal surface of the radome 20 in a horizontal direction (direction parallel with the upper surface of the antenna substrate 30) are the same as a position of each of the antenna elements 31 in a horizontal direction. A number of the wave directors 21-1 and a number of the wave directors 21-2 are also the same as the number of the antenna elements 31. With this arrangement, it is expected that the directivity of the antenna is further largely intensified by the wave directors 21-1 and the wave directors 21-2. However, the positions and the numbers of the respective wave directors 21-1 and wave directors 21-2 are not particularly limited.

Furthermore, as described later, in order to intensify the directivity of the antenna, it is preferable that an interval between each of the wave directors 21-2 and each of the wave directors 21-2 and each interval between each of the wave directors 21-1 and each of the antenna elements 31 are approximately the same as a length of one fourth of a wavelength λ of the radio wave or are slightly shorter than the length of one fourth of the wavelength λ of the radio wave. In addition, as shown in FIG. 1, in order to intensify the directivity of the antenna, it as preferable that each of the wave directors 21 becomes short in accordance with an increase in a distance from each of the antenna elements 31.

Hereinbefore, the configuration example of the antenna device 10A according to the first embodiment of the present disclosure is described.

### 1.2. Description of Effect

Subsequently, effect of the first embodiment of the present disclosure will be described. FIG. 4 is a diagram for explaining comparative examples. With reference to FIG. 4, shown as the comparative examples are a case where one patch antenna element is provided, a case where one dipole antenna element is provided, and a case where a combination of one patch antenna element and a dielectric lens. Note that in general, in many systems (for example, a radar device mounted on an on-vehicle device and the like), as an antenna, the patch antenna is adopted. In addition, each gain shown in FIG. 4 is a value calculated on the basis of simulation.

As shown in FIG. 4, in a case where one patch antenna element is provided, a gain (antenna gain) is small and is 6 dBi. In addition, also in a case where one dipole antenna element is provided, a gain is small and is 2.14 dBi. On the other hand, the case where the combination of the one patch antenna element and the dielectric lens is provided, a gain which is equal to or greater than 26 dBi can be obtained, the 26 dBi being a sum of a gain of 6 dBi of the one patch antenna element and a gain of 20 dBi or more of the dielectric lens.

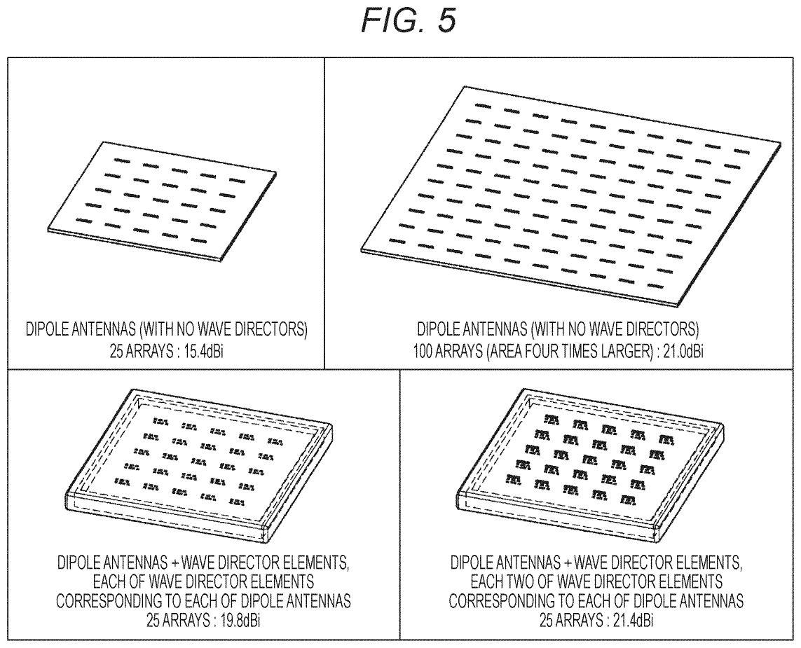

FIG. 5 is a diagram. showing an example of relationship between numbers of dipole antennas and wave directors and each gain. With reference to FIG. 5, shown are a case where 25 dipole antennas (25 arrays) are provided and no wave directors are provided, a case where 100 dipole antennas (100 arrays) are provided and no wave directors are provided, a case where a combination of 25 dipole antennas (25 arrays) and wave director elements (wave directors 21-2) is provided, each of the wave director elements corresponding to each of the dipole antennas, and a case where a combination of 25 dipole antennas (25 arrays) and wave director elements (wave directors 21-1 and wave directors 21-2), each two of the wave director elements corresponding to each of the dipole antennas.

As shown FIG. 5, in a case where the 25 dipole antennas (25 arrays) are provided and no wave directors are provided, a gain is 15.4 dBi. Additionally, in a case where no wave directors are provided and an area of the antenna substrate in a horizontal direction is quadrupled, that is, the case where the 100 dipole antennas (100 arrays) are provided and no wave directors are provided, a gain is increased to 21.0 dBi. However, since it is required to increase the area of the antenna substrate in the horizontal direction, a size of the antenna device is increased.

On the other hand, in a case where the wave director elements (wave directors 21-2) are added in such a way that each of the wave director elements correspond to each of the 25 dipole antennas (25 arrays), a gain is 19.8 dBi. Furthermore, in a case where the wave director elements (wave directors 21-1 and wave directors 21-2) are added in such a way that each two of the wave director elements correspond to each of the 25 dipole antennas (25 arrays), a gain is 21.4 dBi (which is substantially equivalent to the gain in a case where no wave directors are provided and the area of the antenna substrate in the horizontal direction is quadrupled). As in this example, the radome is provided with the wave directors, thereby allowing the gain to be increased even without increasing the size of the antenna device.

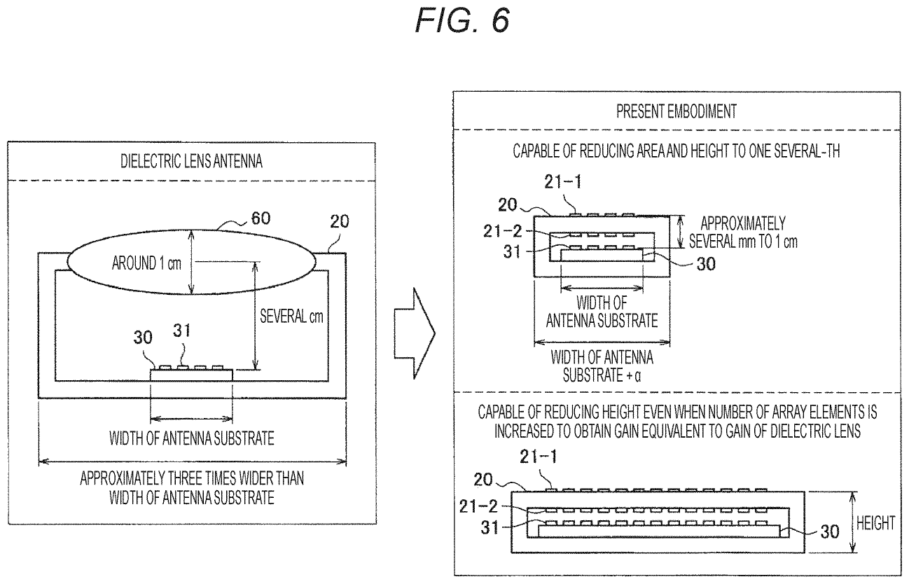

FIG. 6 is a diagram showing comparison of sizes of a dielectric lens antenna and the antenna device according to the present embodiment. As mentioned above, a case where the radio wave transmitted or received by the antenna elements 31 is the millimeter wave is supposed. As shown in FIG. 6, the dielectric lens antenna has a dielectric lens 60, a radome 20, an antenna substrate 30, and antenna elements 31. A thickness of the dielectric lens 60 is around 1 cm. In addition, since as a distance between the dielectric lens 60 and the antenna elements 31, at least a focal distance or so of the dielectric lens 60 is required, the distance therebetween is several cm. A width of the radome 20 in a horizontal direction is three times wider than a width of the antenna substrate (a width of the antenna substrate 30 in the horizontal direction).

On the other hand, as shown in FIG. 6, the antenna device according to the present embodiment has the wave directors 21-1 and the wave directors 21-2 besides the radome 20, the antenna substrate 30, and the antenna elements 31. A distance between each of the wave directors 21-1 provided on the external surface of the radome 20 and each of the antenna elements 31 can be made to be approximately several mm to 1 cm. In addition, since the dielectric lens is unnecessary, it is only required for a width of the radome 20 in a horizontal direction to be wider slightly (by +α) than a width of the antenna substrate (a width of the antenna substrate 30 in the horizontal direction). In other words, according to the present embodiment, an area and a height of the antenna device can be reduced to approximately one several-th of an area and a height in a case where the dielectric lens is used.

Alternatively, as shown in FIG. 6, increasing a number of the array elements (the antenna elements 31, the wave directors 21-1, and the wave directors 21-2) in the horizontal direction is also supposed. This makes it possible to obtain a gain equivalent to a gain in a case where the dielectric lens is used. Even in such a case, the height of the antenna device can be made low, as compared with the case where the dielectric lens is used.

Note that as mentioned above, the kind of the antenna elements 31 is not limited. However, in a case where as each of the antenna elements 31, the dipole antenna is used, radio waves in a wider frequency band than those in a frequency band in a case where the patch antenna is used can be dealt with. Furthermore, since a differential power supply system is used in the dipole antenna, (although a balun is required in a case where a single-end input/output chip is connected to the dipole antenna), the balun is unnecessary in a case where a differential input/output chip is connected to the dipole antenna.

Hereinbefore, the effect of the first embodiment of the present disclosure is described.

### 1.3. Examples of Application

Subsequently, examples of application of the first embodiment of the present disclosure will be described. The antenna device according to the first embodiment of the present disclosure is applicable to various devices.

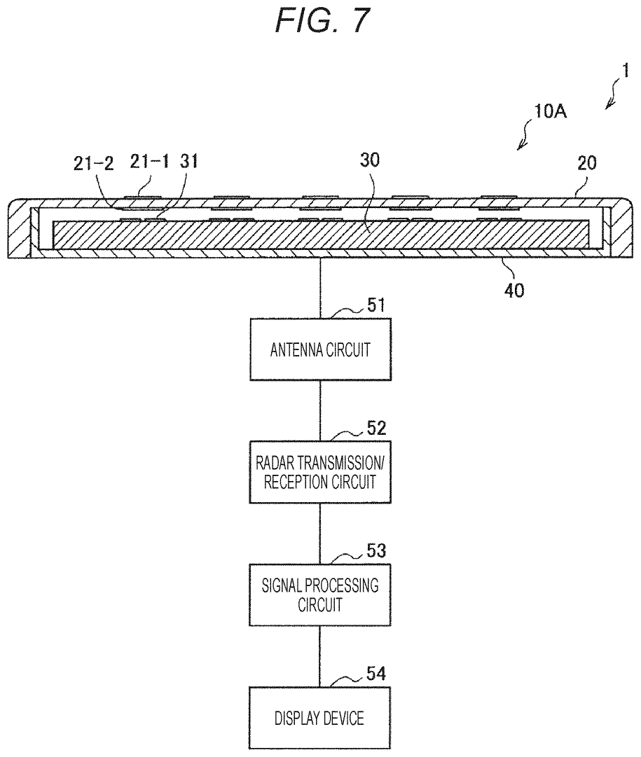

FIG. 7 is a diagram showing a configuration example of a radar device to which the antenna device according to the first embodiment is applied. As shown in FIG. 7, a radar device 1 has the antenna device 10A according to the first embodiment of the present disclosure, an antenna circuit 51, a radar transmission/reception circuit 52, a signal processing circuit 53, and a display device 54. The antenna circuit 51 is an integrated circuit such as a system large-scale integrated circuit (LSI).

The radar transmission/reception circuit 52 emits (transmits) radar waves via antenna elements 31 of the antenna device 10A in accordance with control or the signal processing circuit 53. In addition, the radar transmission/reception circuit 52 receives radar waves reflected by an object (target) via the antenna elements 31 of the antenna device 10A. On the basis of a propagation time (or a frequency change) of the radar waves, the signal processing circuit 53 calculates a distance from the antenna device 10A to the object (target), speed, and the like. The display device 54 displays a result calculated by the signal processing circuit 53.

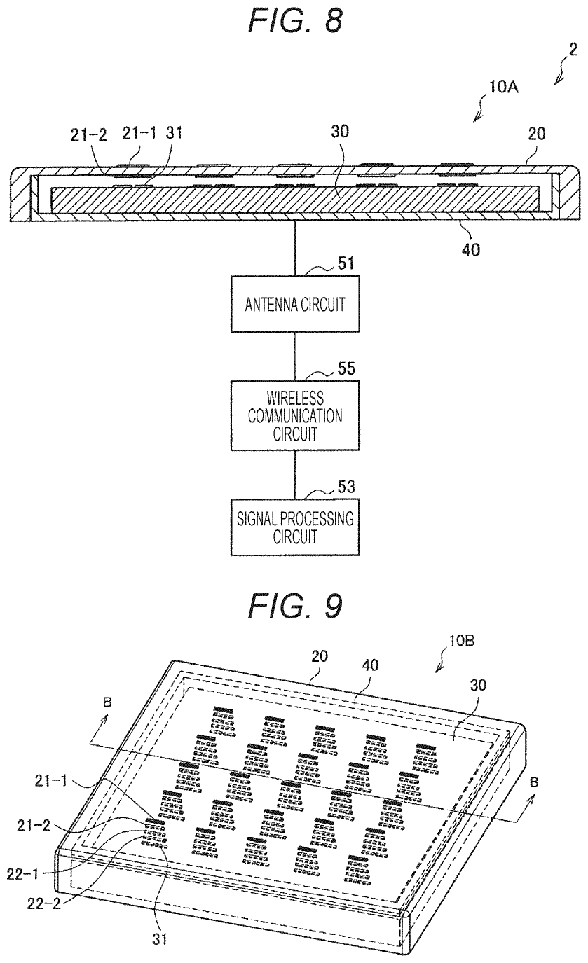

FIG. 8 is a diagram showing a configuration example of a wireless communication device to which the antenna device according to the first embodiment of the present disclosure is applied. As shown in FIG. 8, the wireless communication device 2 has the antenna device 10A according to the first embodiment of the present disclosure, an antenna circuit 51, a wireless communication circuit 55, and a signal processing circuit 53. The wireless communication circuit 55 modulates a baseband signal output from the signal processing circuit 53 and emits (transmits) the modulated wireless signal via antenna elements 31 of the antenna device 10A. In addition, the wireless communication circuit 55 demodulates the wireless signal received by the antenna elements 31 of the antenna device 10A and outputs the demodulated baseband signal to the signal processing circuit 53.

Hereinbefore, the examples of application of the first embodiment of the present disclosure are described.

### 2. Detail of Second Embodiment

Hereinafter, detail of a second embodiment of the present disclosure will be described.

### 2.1. Configuration Example of Antenna Device

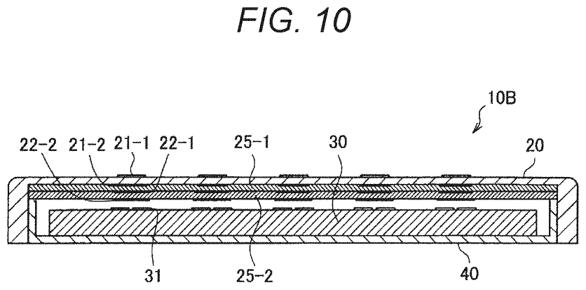

Subsequently, a configuration example of an antenna device according to the second embodiment of the present disclosure will be described. FIG. 9 is an external view of the antenna device according to the second embodiment of the present disclosure. In addition, FIG. 10 is a cross-sectional view of an antenna device 10B, viewed along arrows B-B shown in FIG. 9.

As shown in FIGS. 9 and 10, as compared with the antenna device 10A according to the first embodiment of the present disclosure, the antenna device 10B according to the second embodiment of the present disclosure further has wave directors 22-1 (second wave directors) and wave directors 22-2 (second wave directors). Accordingly, hereinafter, the wave directors 22-1 and the wave directors 22-2 will be mainly described, and detailed description as to the other components will be appropriately omitted.

Also in the second embodiment of the present disclosure, as similar to the first embodiment of the present disclosure, on an external surface of a radome 20, wave directors 21-1 (first wave directors) are provided, and on an internal surface of the radome 20, wave directors 21-2 (first wave directors) are provided. In the second embodiment of the present disclosure, the antenna device 10B further includes: the wave directors 22-1 and the wave directors 22-2 which are provided in such a way as to be laminated on the wave directors 21-1 (first wave directors) or the wave directors 21-2 (first wave directors). By employing the above-mentioned configuration, directivity of the antenna is further largely intensified by the wave directors 22-1 and the wave directors 22-2. Note that although in the example shown in FIGS. 9 and 10, the wave directors 22 are provided in two stages, it is not necessarily required to provide the wave directors 22 in the two stages, and the wave directors 22 in one stage may be provided, or the wave directors 22 in three or more stages may be provided.

Furthermore, in the example shown in FIGS. 9 and 10, the wave directors 22 are provided in positions, which are separated from each other, from the internal surface of the radome 20 to an inside of the radome 20. However, the wave directors 22 may be provided in positions, which are separated from each other, from the external surface of the radome 20 to an outside of the radome 20. In other words, the wave directors 22 may be provided in at least any one of: the positions, which are separated from each other, from the external surface of the radome 20 to the outside of the radome 20; or the positions, which are separated from each other, from the internal surface of the radome 20 to the inside of the radome 20. This intensifies the directivity of the antenna. At this time, a number of stages in which the wave directors 22 are provided in the positions, which are separated from each other, from the external surface of the radome 20 to the outside of the radome 20 is also not limited.

The wave directors 22-1 may be formed on a dielectric sheet 25-1 (by using laser plating or the like) by patterning. Additionally, the dielectric sheet 25-1 may be fixed on the internal surface (or the wave directors 21-2) of the radome 20 by an adhesive. The adhesive can also include a double-sided tape. In addition, in FIGS. 9 and 10, in consideration of simplicity of the drawings, the adhesive is omitted. In addition, the wave directors 22-2 may be formed on a dielectric sheet 25-2 (by using laser plating or the like) by patterning. Additionally, the dielectric sheet 25-2 may be fixed on the dielectric sheet 25-1 (or the wave directors 22-1) by an adhesive. With this arrangement, the wave directors 22-1 and the wave directors 22-2 can be easily provided in the positions, which are separated from each other, from the internal surface of the radome 20 to the inside of the radome 20.

Note that it is desirable that as a material of each of the dielectric sheet 25-1 and the dielectric sheet 25-2, in order to inhibit a transmission loss of the radio waves, a material whose permittivity is low and dielectric loss tangent is low is also selected. For example, the dielectric sheet 25-1 and the dielectric sheet 25-2 may be configured to contain plastic. In addition, it is desirable that as a material of the adhesive, in order to inhibit a transmission loss of the radio waves, a material whose permittivity is low and dielectric loss tangent is low is also selected.

Although in FIGS. 9 and 10, reference signs are appropriately omitted, the positions in a horizontal direction, in which the wave directors 22-1 and the wave directors 22-2 are provided, the positions separated from each other from the internal surface of the radome 20 to the inside of the radome 20, are the same as positions in the horizontal direction, in which the antenna elements 31 are provided. Each of a number of the wave directors 22-1 and a number of the wave directors 22-2 is also the same as a number of the antenna elements 31. With this arrangement, it is expected that the directivity of the antenna is further largely intensified by the wave directors 22-1 and the wave directors 22-2. However, the positions and the numbers of the respective wave directors 22-1 and wave directors 22-2 are not limited.

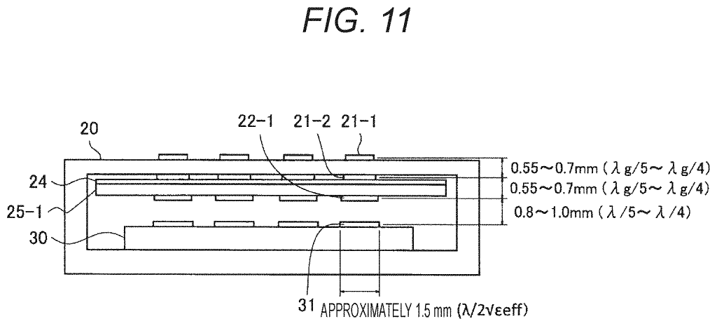

FIG. 11 is a diagram showing an example in which lengths of respective portions of the antenna device 10B according to the second embodiment of the present disclosure are shown. In the example shown in FIG. 11, a case where the dielectric sheets 25-2 and the wave directors 22-2 shown in FIGS. 9 and 10 are not present is supposed. As shown in FIG. 11, it is desirable that a width of each of the antenna elements 31 is set to a length (approximately 1.5 mm) which is calculated by a product of one half of a wavelength λ of a radio wave in the air and a wavelength shortening rate (a positive square root of an effective relative permittivity εeff).

In addition, in order to intensify the directivity of the antenna, as shown in FIG. 11, it is preferable that each of an interval between each of the wave directors 21-1 and each of the wave directors 21-2 and an interval between each of the wave directors 21-2 and each of the wave directors 22-1 are approximately the same as a length of one fifth to one fourth of a wavelength λg of a radio wave inside a dielectric. On the other hand, it is preferable that an interval of each of the wave directors 22-1 and each of the antenna elements 31 is approximately the same as a length of one fifth to one fourth of the wavelength λ of the radio wave in the air. In addition, as shown in FIG. 11, in order to intensify the directivity of the antenna, it is preferable that each of the wave directors 21 and each of the wave directors 22 become short in accordance with an increase in a distance from each of the antenna elements 31.

Hereinbefore, the configuration example of the antenna device 10B according to the second embodiment of the present disclosure is described.

### 2.2. Description of Effect

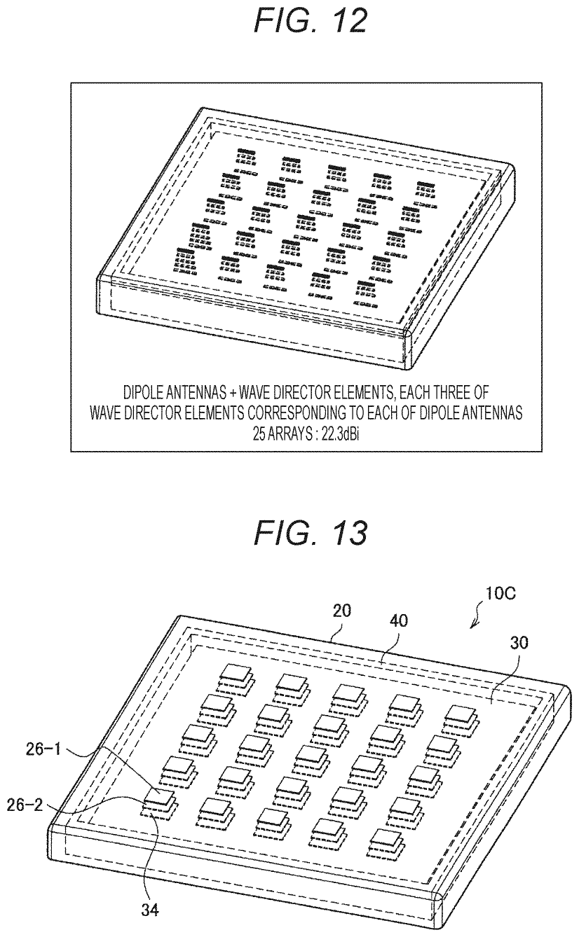

Subsequently, effect of the second embodiment of the present disclosure will be described. FIG. 12 is a diagram showing an example of relationship of respective numbers of dipole antennas and wave directors and a gain. With reference to FIG. 12, shown is a case where a combination of the 25 dipole antennas (25 arrays) and the wave director elements (wave directors 21-1, wave directors 21-2, and wave directors 22-1) are provided, three elements of each of the wave directors 21-1, each of the wave directors 21-2, and each of the wave directors 22-1 corresponding to each of the dipole antennas.

As shown in FIG. 12, in a case where the wave director elements (the wave directors 21-1, the wave directors 21-2, and the wave directors 22-1) are added, the three elements of each of the wave directors 21-1, each of the wave directors 21-2, and each of the wave directors 22-1 corresponding to each of the 25 dipole antennas (25 arrays), a gain is 22.3 dBi. As in this example, the wave directors are provided in such a way as to be laminated in the radome in three stages, thereby allowing a gain to be largely increased without increasing a size of the antenna device.

Hereinbefore, the effect of the second embodiment of the present disclosure is described.

### 3. Modified Examples

Hereinbefore, although with reference to the accompanying drawings, the preferred embodiments of the present disclosure are described in detail, a technical scope of the present disclosure is not limited to the above-described examples. It is apparent to those having ordinary knowledge in the technical field of the present disclosure to arrive at a variety of modified examples or corrected examples within a technical idea described in the claims, and it is naturally understood that these belong to the technical scope of the present disclosure.

FIG. 13 is an external view of an antenna device according to a first modified example. With reference to FIG. 13, an antenna device 10C according to the first modified example is shown. In the example shown in FIG. 13, as compared with the example shown in FIG. 2, the antenna elements 31 (dipole antennas) are replaced with antenna elements 34 (patch antennas). In accordance therewith, the wave directors 21-1 are also replaced with wave directors 26-1, each of which has a size and a shape corresponding to each of the patch antennas, and the wave directors 21-1 are also replaced with wave directors 26-2, each of which has a size and a shape corresponding to each of the patch antennas.

Note that although in FIG. 13, the example in which the first modified example is applied to the antenna device 10A according to the first embodiment of the present disclosure is shown, the first modified example may be applied to the antenna device 10B according to the second embodiment of the present disclosure. In other words, the wave directors 22-1 and the wave directors 22-2 may also be replaced with the wave directors 26-2, each of which has the size and the shape corresponding to each of the patch antennas. As described above, a kind of the antenna may be appropriately changed, and in accordance therewith, a size and a shape of each of the wave directors may be changed.

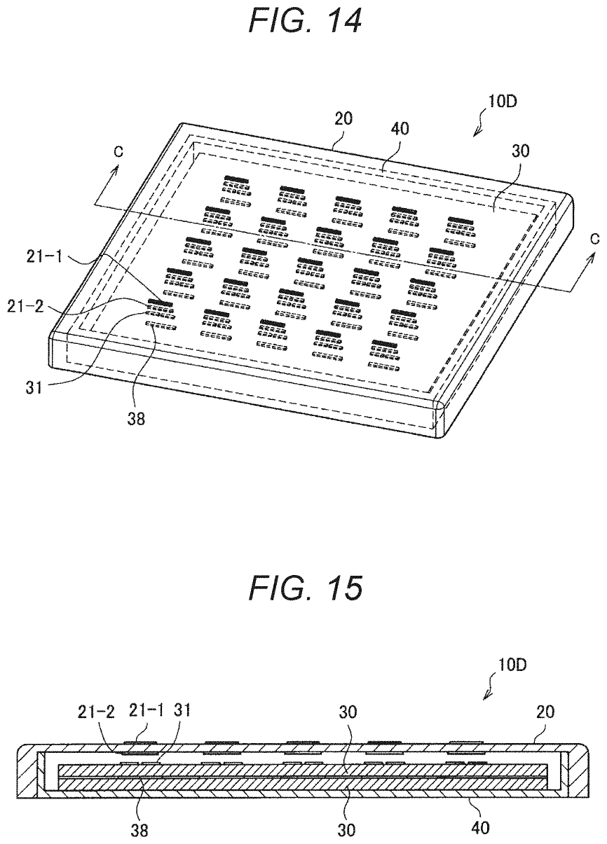

FIG. 14 is an external view of an antenna device according to a second modified example. With reference to FIG. 14, an antenna device 10D according to the second modified example is shown. In addition, FIG. 15 is a cross-sectional view of the antenna device 10D, viewed along arrows C-C shown in FIG. 14. In the example shown in FIGS. 14 and 15, as compared with the example shown in FIGS. 2 and 3, a reflector 38 is provided. It is expected that directivity of the antenna is further intensified by reflection of radio waves by the reflector 38.

In the example shown in FIG. 15, the reflector 38 is provided inside an antenna substrate 30. However, it is only required for the reflector 38 to be provided on a side opposite to a side of a position of each of wave directors 21 with reference to a position of each of antenna elements 31. For example, the reflector 38 may be provided on a surface of the antenna substrate 30 (for example, a lower surface of the antenna substrate 30). In any case, it is preferable that an interval between each of the antenna elements 31 and the reflector 38 is approximately the same as a length of one fifth to one fourth of a wavelength λg of a radio wave inside a dielectric.

Hereinbefore, the modified examples are described.

### 4. Closing Remarks

As described hereinbefore, according to the embodiments of the present disclosure, provided is an antenna device which includes: antenna elements, each of which transmits or receives a radio wave; a radome which covers the antenna elements; and one first wave director or a plurality of first wave directors which is provided on at least one of an external surface or an internal surface of the radome.

By employing the above-described configuration, directivity of the antenna is intensified, thereby, allowing antenna performance to be enhanced even without making a shape of the radome a complicated shape. Accordingly, by employing the above-described configuration, the antenna performance can be enhanced while manufacturing costs of the antenna device are reduced and a size of the antenna device is inhibited from increasing. As one example, the directivity of the antenna is intensified and resolution of the object detection based on the reception result of the reflected wave is thereby enhanced, thus enabling the object detection to be performed at a high accuracy.

In addition, the effect described in the present description is merely explanatory or illustrative rather than restrictive. In other words, the technology according to the present disclosure can exhibit the above-described effect as well as, or instead of the above-mentioned effect, other effect which is apparent to those skilled in the art from the contents of the present description.

Note that the below-described configurations also belong to the technical scope of the present disclosure.

(1)

An antenna device including:

an antenna element that transmits or receives a radio wave;

a radome that covers the antenna element; and

one first wave director or a plurality of first wave directors that is provided on at least any one of an external surface or an internal surface of the radome.

(2)

The antenna device according to the above-mentioned (1),

in which the first wave director or the first wave directors is or are formed on the at least any one of the external surface or the internal surface of the radome by patterning.

(3)

The antenna device according to the above-mentioned (1) or (2),

in which the first wave director or the first wave directors is or are provided on the external surface and the internal surface of the radome.

(4)

The antenna device according to any one of the above-mentioned (1) to (3), further including one second wave director or a plurality of second wave directors that is provided in such a way as to be laminated on the first wave director or the first wave directors.

(5)

The antenna device according to the above-mentioned (4),

in which the second wave director or the second wave directors is or are provided in at least any one of: a position or positions being separated from the external surface to an outside of the radome; or a position or positions being separated from the internal surface to an inside of the radome.

(6)

The antenna device according to any one of the above-mentioned (1) to (5),

in which the antenna element includes at least any one of a patch antenna, a dipole antenna, a loop antenna, or a metamaterial antenna.

(7)

The antenna device according to any one of the above-mentioned (1) to (6),

in which the antenna device is mounted on an on-vehicle device, a drone, a robot, a mobile device, or a speaker.

(8)

The antenna device according to any one of the above-mentioned (1) to (7), further including

a reflector inside an antenna substrate or on a surface of the antenna substrate.

(9)

A wireless communication device including:

an antenna device that includes:

an antenna element that transmits or receives a wireless signal;

a radome that covers the antenna element; and

one first wave director or a plurality of first wave directors that is provided on at least any one of an external surface or an internal surface of the radome; and

a wireless communication circuit that causes the antenna element to transmit or receive the wireless signal.

(10)

A radar device including:

an antenna device that includes:

an antenna element that transmits or receives a radar wave;

a radome that covers the antenna element; and

one first wave director or a plurality of first wave directors that is provided on at least any one of an external surface or an internal surface of the radome; and

a radar transmission circuit that causes the antenna element to transmit or receive the radar wave.

### REFERENCE SIGNS LIST

1 Radar device
2 Wireless communication device
10A to 10D Antenna device
20 Radome
21 Wave director
22 Wave director
25 Dielectric sheet
26 Wave director
30 Antenna substrate
31 Antenna element
34 Antenna element
38 Reflector
40 Housing
51 Antenna circuit
52 Radar transmission/reception circuit
53 Signal processing circuit
54 Display device
55 Wireless communication circuit
60 Dielectric lens

1. An antenna device comprising:
an antenna element that transmits or receives a radio wave;
a radome that covers the antenna element; and
one first wave director or a plurality of first wave directors that is provided on at least any one of an external surface or an internal surface of the radome.

2. The antenna device according to claim 1, wherein the first wave director or the first wave directors is or are formed on the at least any one of the external surface or the internal surface of the radome by patterning.

3. The antenna device according to claim 1, wherein the first wave director or the first wave directors is or are provided on the external surface and the internal surface of the radome.

4. The antenna device according to claim 1, further comprising
one second wave director or a plurality of second wave directors that is provided in such a way as to be laminated on the first wave director or the first wave directors.

5. The antenna device according to claim 4,
wherein the second wave director or the second wave directors is or are provided in at least any one of: a position or positions being separated from the external surface to an outside of the radome; or a position or positions being separated from the internal surface to an inside of the radome.

6. The antenna device according to claim 1,
wherein the antenna element includes at least any one of a patch antenna, a dipole antenna, a loop antenna, or a metamaterial antenna.

7. The antenna device according to claim 1,
wherein the antenna device is mounted on an on-vehicle device, a drone, a robot, a mobile device, or a speaker.

8. The antenna device according to claim 1, further comprising
a reflector inside an antenna substrate or on a surface of the antenna substrate.

9. A wireless communication device comprising:
an antenna device that includes:
an antenna element that transmits or receives a wireless signal;
a radome that covers the antenna element; and
one first wave director or a plurality of first wave directors that is provided on at least any one of an external surface or an internal surface of the radome; and
a wireless communication circuit that causes the antenna element to transmit or receive the wireless signal.

10. A radar device comprising:
an antenna device that includes:
an antenna element that transmits or receives a radar wave;
a radome that covers the antenna element; and
one first wave director or a plurality of first wave directors that is provided on at least any one of an external surface or an internal surface of the radome; and
a radar transmission circuit that causes the antenna element to transmit or receive the radar wave.
